(19) United States
(12) Patent Application Publication
(10) Pub. No.: US 2024/0372222 A1
(43) Pub. Date: Nov. 7, 2024

(54) BATTERY ARRAY ELECTRICAL CONNECTION SYSTEM AND METHOD FOR ELECTRICALLY CONNECTING BATTERY ARRAYS

(71) Applicant: Ford Global Technologies, LLC, Dearborn, MI (US)

(72) Inventors: Liam E. West, Ferndale, MI (US); Francisco Fernandez-Galindo, Canton, MI (US); Daniel Paul Roberts, Livonia, MI (US); Dominic Mario Bertolini, Birmingham, MI (US); Vedat Haydin, Canton, MI (US)

(21) Appl. No.: 18/310,579

(22) Filed: May 2, 2023

(51) Int. Cl. H01M 50/503; H01M 50/507

(52) U.S. Cl. CPC H01M 50/503; H01M 50/507; H01M 2220/20

(57) ABSTRACT

An electrical connection system for a traction battery pack includes a first battery array, a second battery array, and a plug-and-socket coupler that electrically connects the first battery array to the second battery array when in an engaged position. A method of electrically connecting battery arrays of a traction battery includes electrically connecting a first battery array to a second battery array by moving the first battery array relative to the second battery array.

### TECHNICAL FIELD

This disclosure relates generally to electrical connections within a traction battery pack.

### BACKGROUND

A traction battery pack of an electrified vehicle can include groups of battery cells arranged in one or more battery arrays. The battery arrays can be electrically connected to each other.

### SUMMARY

In some aspects, the techniques described herein relate to an electrical connection system for a traction battery pack, including: a first battery array; a second battery array; and a plug-and-socket coupler that electrically connects the first battery array to the second battery array when in an engaged position.

In some aspects, the techniques described herein relate to an electrical connection system, further including a first connector assembly of the plug-and-socket coupler and a second connector assembly of the plug-and-socket coupler, the first connector assembly electrically connected to a first busbar of the first battery array, the second connector assembly is electrically connected to a second busbar of the second battery array.

In some aspects, the techniques described herein relate to an electrical connection system, wherein the first connector assembly includes a cylindrical terminal that receives a pin-style terminal of the second connector assembly when the plug-and-socket coupler is in the engaged position.

In some aspects, the techniques described herein relate to an electrical connection system, further including a guard of the first connector assembly, the guard extending into an opening of the cylindrical terminal.

In some aspects, the techniques described herein relate to an electrical connection system, wherein the guard is pin-shaped.

In some aspects, the techniques described herein relate to an electrical connection system, wherein, when the plug-and-socket coupler is in the engaged position, the guard is received within an opening of the pin-style terminal such that the pin-style terminal is radially between the guard and the cylindrical terminal.

In some aspects, the techniques described herein relate to an electrical connection system, wherein the cylindrical terminal is a radial socket.

In some aspects, the techniques described herein relate to an electrical connection system, wherein the first connector assembly faces horizontally outward from the first battery array and is configured to receive the second connector assembly horizontally.

In some aspects, the techniques described herein relate to an electrical connection system, wherein the first connector assembly faces vertically upward and is configured to receive the second connector assembly vertically.

In some aspects, the techniques described herein relate to an electrical connection system, further including a first housing of the first connector assembly, and a second housing of the second connector assembly, wherein the first housing and the second housing are snap-fit to each other when the plug-and-socket coupler is in the engaged position.

In some aspects, the techniques described herein relate to an electrical connection system, wherein the plug-and-socket coupler is configured to be transitioned from a disengaged position to an engaged position by moving the first battery array and the second battery array relative to each other.

In some aspects, the techniques described herein relate to an electrical connection system, wherein the plug-and-socket coupler to be transitioned from a disengaged position to the engaged position by translating the second battery array horizontally relative to the first battery array.

In some aspects, the techniques described herein relate to an electrical connection system, further including a wedge and an enclosure, the wedge inhibiting movement of the first battery array away from the second battery array.

In some aspects, the techniques described herein relate to an electrical connection system, wherein the plug-and-socket coupler is configured to be transitioned from a disengaged position to the engaged position by translating the second battery array vertically relative to the first battery array.

In some aspects, the techniques described herein relate to an electrical connection system, wherein the first battery array, the second battery array, and the plug-and-socket coupler are within an enclosure of the traction battery pack.

In some aspects, the techniques described herein relate to a method of electrically connecting battery arrays of a traction battery, including: electrically connecting a first battery array to a second battery array by moving the first battery array relative to the second battery array.

In some aspects, the techniques described herein relate to a method, wherein the moving is horizontal.

In some aspects, the techniques described herein relate to a method, wherein the moving is vertical.

In some aspects, the techniques described herein relate to a method, further including electrically connecting by transitioning a plug-and-socket coupler to an engaged position.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1 having battery arrays electrically connected to each other with plug-and-socket couplers according to an exemplary embodiment of the present disclosure and portions of an enclosure tray removed to show one of the plug-and-socket couplers.

FIG. 3 illustrates a battery cell from the traction battery pack of FIG. 2.

FIG. 4 illustrates a perspective view of a first connector of the plug-and-socket coupler shown in FIG. 2.

FIG. 5 illustrates another perspective view of the first connector of FIG. 4.

FIG. 6 illustrates an expanded view perspective view of the first connector of FIG. 4.

FIG. 7 illustrates a perspective view of a second connector of the plug-and-socket coupler of FIG. 2.

FIG. 8 illustrates another perspective view of the second connector of FIG. 7.

FIG. 9 illustrates an expanded view perspective view of the second connector of FIG. 7

FIG. 10 illustrates a close-up section view at line 10-10 in FIG. 2 prior to electrically coupling together battery arrays of the battery pack using a plug-and-socket coupler.

FIG. 11 illustrates the close-up section view in FIG. 10 after electrically coupling together battery arrays using the plug-and-socket coupler.

FIGS. 12A-12E schematically illustrates selected steps of assembling the battery arrays within the battery pack of FIG. 2 using plug-and-socket couplers.

FIG. 13A illustrates a close-up section view of a plug and socket coupler according to another exemplary aspect of the present disclosure prior to electrically coupling together battery arrays of the battery pack using the plug-and-socket coupler.

FIG. 13B illustrates a close-up section view of the plug and socket coupler of FIG. 13A after electrically coupling together battery arrays of the battery pack using the plug-and-socket coupler.

### DETAILED DESCRIPTION

This disclosure details exemplary couplers that electrically connect together components of a traction battery pack. The electrical connection systems can be plug-and-socket connection couplers.

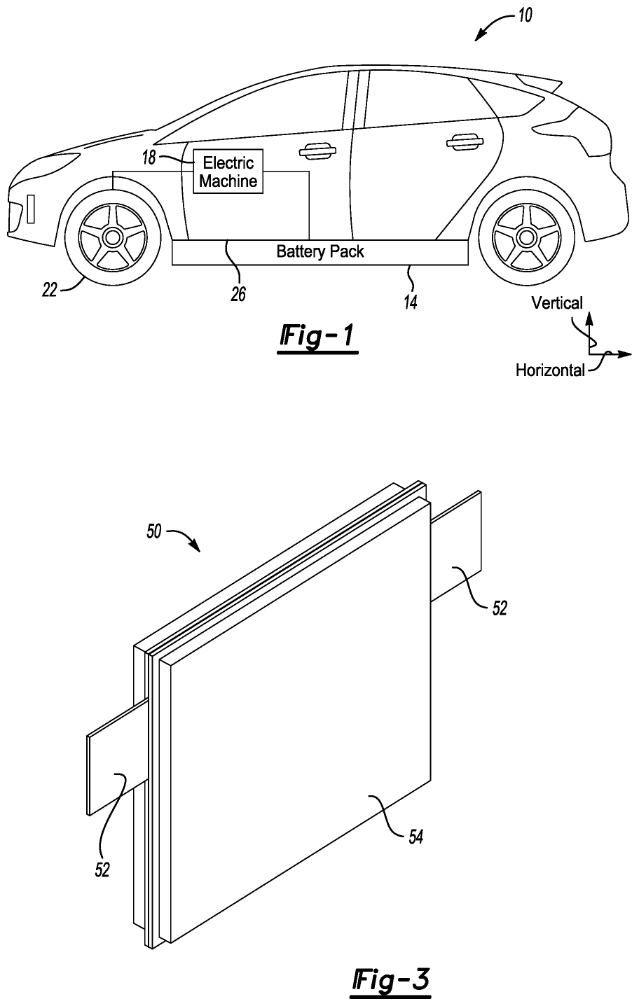

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

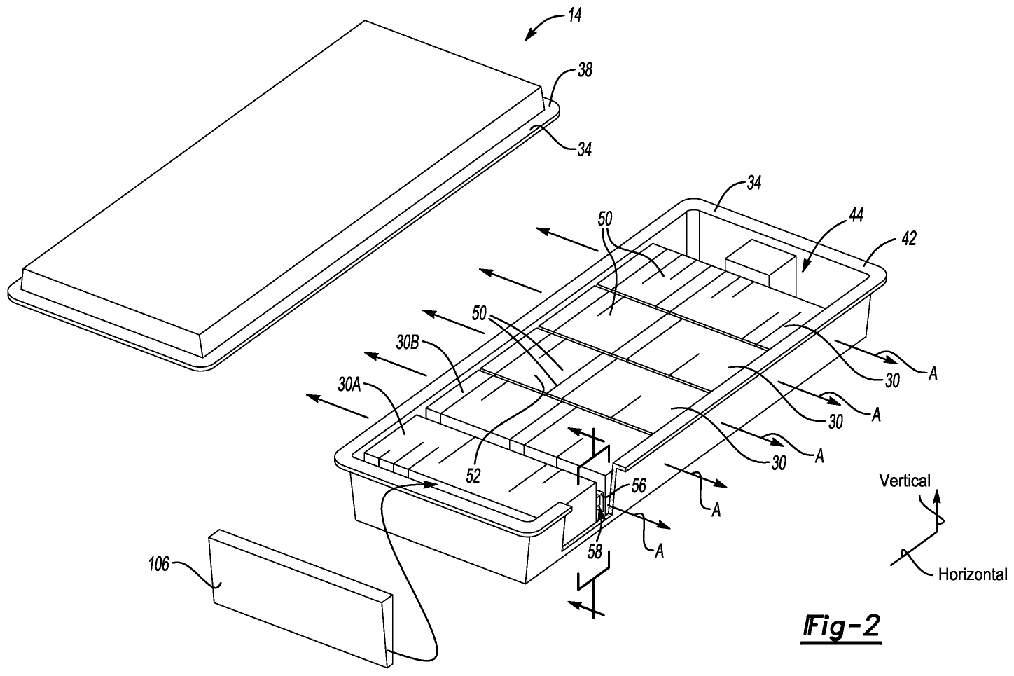

With reference now to FIGS. 2 and 3, the traction battery pack 14 includes a plurality of battery arrays 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the battery arrays 30. The enclosure cover 38 can be secured to the enclosure tray 42 using mechanical fasteners (not shown), for example.

Each of the battery arrays 30 includes, among other things, a plurality of battery cells 50 (or simply “cells”) stacked side-by-side relative to each along a respective battery array axis A. The battery cells 50 store and supply electrical power. In this example, the axes A of the battery arrays 30 are parallel to each other and extend longitudinally in a cross-vehicle direction. Although a specific number of the battery arrays 30 and cells 50 are illustrated in the various figures of this disclosure, the traction battery pack 14 could include any number of the battery arrays 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure.

Each of the example battery cells 50 includes a pair of tab terminals 52 extending from case 54. Within a given one of the battery arrays 30, the individual battery cells 50 can be electrically connected together. To provide these electrical connections, the tab terminals 52 of the battery cells 50 can be connected to the tab terminals 52 of other battery cells 50, to a busbar 56 of the battery array 30, or both.

In this example, the battery arrays 30 are electrically connected to each other using a plug-and-socket coupler 58. In FIG. 2, the plug-and-socket coupler 58 is shown electrically connecting battery array 30A to battery array 30B. Other plug-and-socket couplers 58 are used to electrically connect the other battery arrays 30 of the battery pack 14.

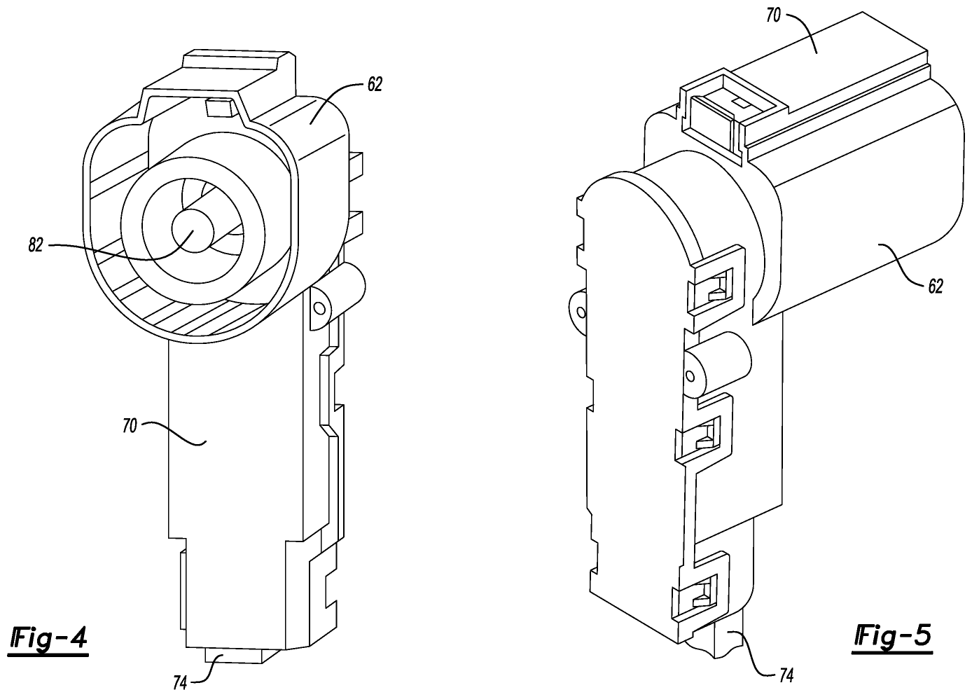

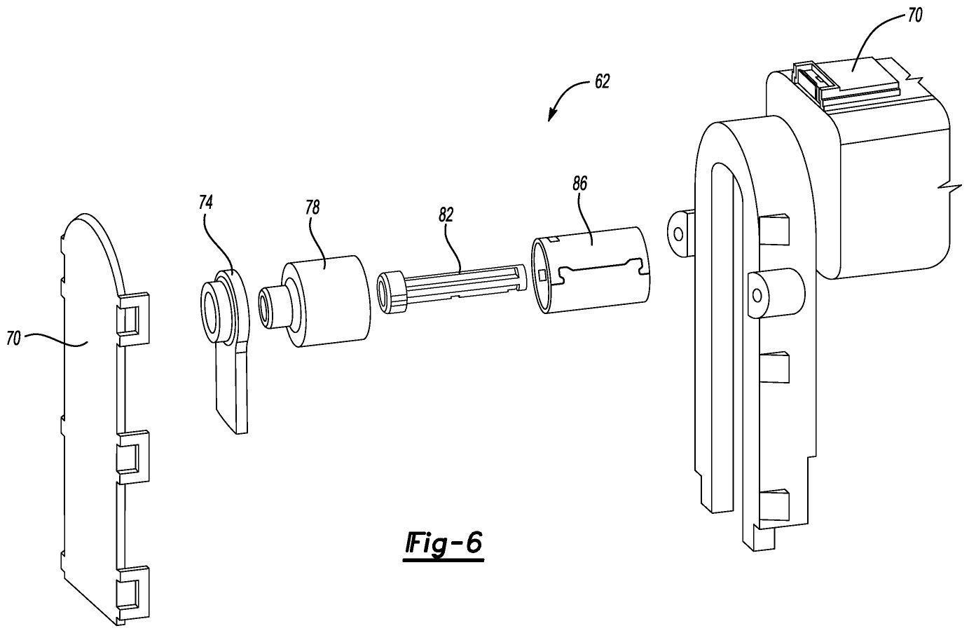

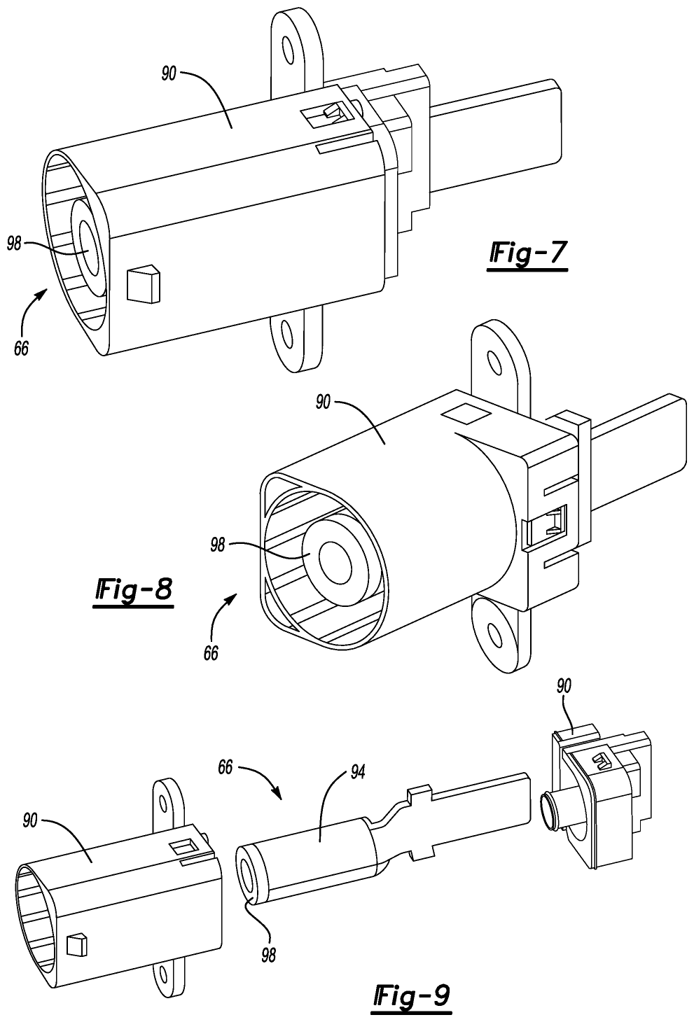

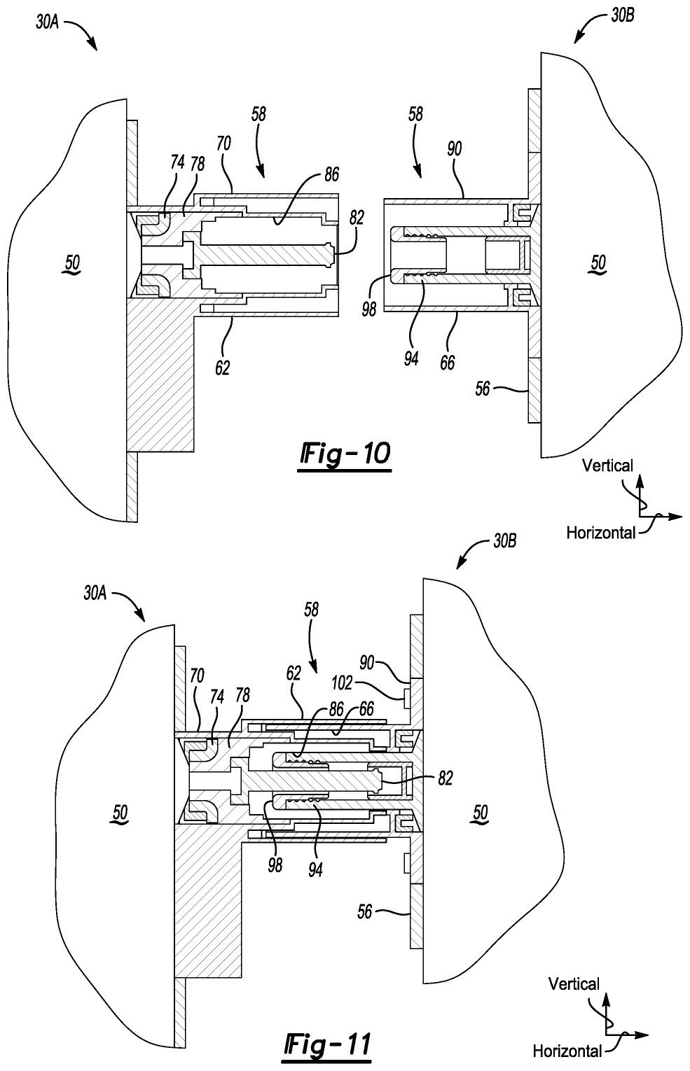

With reference to FIGS. 4-11 and continuing reference to FIG. 2, the arrays 30 of the pack 14 are each electrically connected to at least one of the other arrays 30 using one of the plug-and-socket coupler 58.

The plug-and-socket couplers 58 each include, in this example, a first connector assembly 62 and a second connector assembly 66. The first connector assembly 62 engages the second connector assembly 66 when the plug-and-socket coupler 58 is in the engaged position and electrically connecting respective battery arrays 30. The first connector assembly 62 can be disengaged from the second connector assembly 66 to transition the plug-and-socket coupler 58 to a disengaged position and electrically disconnect the battery arrays 30 from each other.

In the exemplary embodiment of the plug-and-socket coupler 58, the first connector assembly 62 includes a first housing 70 that holds a busbar terminal 74, a press-fit terminal 78, a guard 82, and a cylindrical terminal 86. The example second connector assembly 66 includes a second housing 90, and a pin-style terminal 94 capped by a guard 98.

The busbar terminal 74 of the first connector assembly 62 is electrically coupled to a busbar of the array 30A. The first housing 70 can be secured directly to the array 30A using, for example, mechanical fasteners, to hold the first connector assembly 62 in a position where the busbar terminal 74 is electrically coupled to the array 30A. Within the first housing 70, the press-fit terminal 78, and the cylindrical terminal 86 are electrically coupled to the busbar terminal 74.

The pin-style terminal 94 is electrically coupled to the busbar 56 of the array 30B. The second housing 90 can be secured directly to the array 30B using, for example, mechanical fasteners 102, to hold the pin-style terminal 94 in a position were the pin-style terminal 94 is electrically coupled to the array 30A.

When the plug-and-socket coupler 58 is in the engaged position, the first housing 70 is snap-fit to the second housing 90 to help hold the plug-and-socket coupler 58 in the engaged position.

When the plug-and-socket coupler 58 is in the engaged position, the cylindrical terminal 86 of the first connector assembly 62 contacts the pin-style terminal 94 of the second connector assembly 66 to electrically connect the array 30A to the array 30B.

When the plug-and-socket coupler 58 is in the engaged position, the cylindrical terminal 86 of the first connector assembly 62 receives the pin-style terminal 94 of the second connector assembly 66. The cylindrical terminal 86 can be considered a radial socket in some examples. At least the cylindrical terminal 86 and pin-style terminal 94 can be part of an interconnection assembly sold under the trademark AMPHENOL.

When the when the plug-and-socket coupler 58 is in the engaged position, the guard 82 is received within an opening of the pin-style terminal 94 such that the pin-style terminal 94 is radially between the guard 82 and the cylindrical terminal 86.

The guard 82 is a dielectric. The guard 82 is pin-shaped and extends into the cylindrical terminal 86. The guard 82 can block items, such as a finger of a user, from being inserted into the cylindrical terminal 86 when the plug-and-socket coupler 58 is in the disengaged position.

In the exemplary embodiment, the first connector assembly 62 faces horizontally outward from the first battery array 30A and is configured to receive the second connector assembly 66 horizontally as the plug-and-socket coupler 58 is moved from the disengaged position to the engaged position. Horizontal, for purposes of this disclosure, is with reference to ground and a general orientation of the battery pack 14 when installed within the vehicle 10.

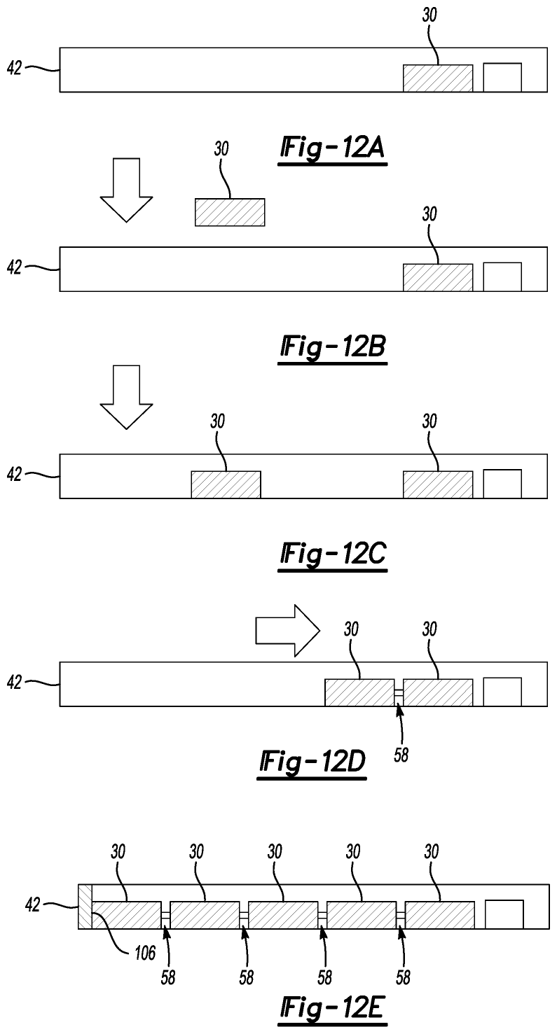

The ability to electrically couple the arrays 30 through the plug-and-socket coupler 58 can facilitate assembly. An array 30 can be placed into the enclosure tray 42 as shown in FIG. 12A and secured to the enclosure tray 42. Next, another array 30 can be placed in the enclosure tray 42 as shown in FIGS. 12B and 12C, and then translated horizontally toward the other array 30 as shown in FIG. 12D until reaching the installed position. The plug-and-socket coupler 58 engages as the arrays 30 move toward the position of FIG. 12D. Installation thus, in this example, does not require a separate step to electrically connect arrays 30.

The additional arrays 30 of the battery pack 14 are added to the enclosure tray 42 and slid horizontally into an installed position. As shown in FIG. 12E, a wedge 106 or spacer can then be added between a wall of the enclosure tray 42 and the arrays 30 to help maintain a horizontal position of the arrays 30. The wedge 106 can inhibit horizontal movement of the arrays 30 away from each other.

The example battery pack 14 includes a single tier of the arrays 30. In another example, additional tiers of arrays 30 could be installed atop the tier shown to provide a battery pack with multiple tiers. The additional tiers of arrays 30 can be electrically coupled together using plug-and-socket-connectors.

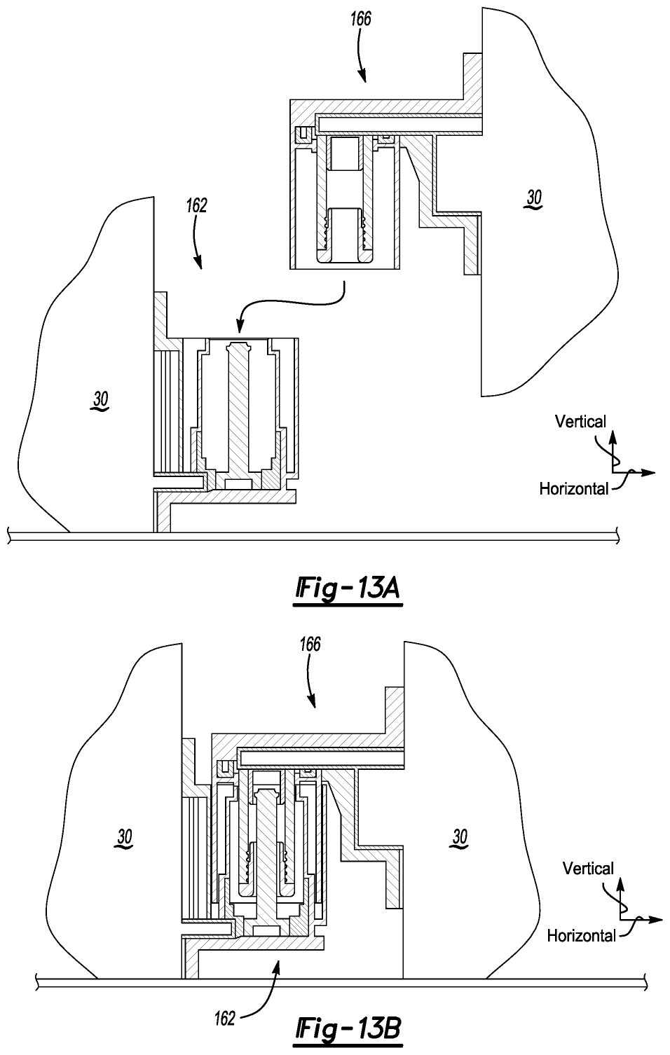

Referring to FIGS. 13A and 13B, another example plug-and-socket coupler 158 includes a first connector 162 that faces vertically upward and a second connector 166 that faces vertically downward. The plug-and-socket coupler 158 can be transitioned from a disengaged position to the engaged position by translating the array 30 having the second connector vertically downward relative to the first connector 162 of the other array 30.

Features of the disclosed examples include plug-and-socket couplers that can be engaged by translating arrays relative to each other. When engaged, the plug-and-socket couplers electrically connect the arrays.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An electrical connection system for a traction battery pack, comprising:
a first battery array;
a second battery array; and
a plug-and-socket coupler that electrically connects the first battery array to the second battery array when in an engaged position.

2. The electrical connection system of claim 1, further comprising a first connector assembly of the plug-and-socket coupler and a second connector assembly of the plug-and-socket coupler, the first connector assembly electrically connected to a first busbar of the first battery array, the second connector assembly is electrically connected to a second busbar of the second battery array.

3. The electrical connection system of claim 2, wherein the first connector assembly comprises a cylindrical terminal that receives a pin-style terminal of the second connector assembly when the plug-and-socket coupler is in the engaged position.

4. The electrical connection system of claim 3, further comprising a guard of the first connector assembly, the guard extending into an opening of the cylindrical terminal.

5. The electrical connection system of claim 4, wherein the guard is pin-shaped.

6. The electrical connection system of claim 4, wherein, when the plug-and-socket coupler is in the engaged position, the guard is received within an opening of the pin-style terminal such that the pin-style terminal is radially between the guard and the cylindrical terminal.

7. The electrical connection system of claim 3, wherein the cylindrical terminal is a radial socket.

8. The electrical connection system of claim 2, wherein the first connector assembly faces horizontally outward from the first battery array and is configured to receive the second connector assembly horizontally.

9. The electrical connection system of claim 2, wherein the first connector assembly faces vertically upward and is configured to receive the second connector assembly vertically.

10. The electrical connection system of claim 2, further comprising a first housing of the first connector assembly, and a second housing of the second connector assembly, wherein the first housing and the second housing are snap-fit to each other when the plug-and-socket coupler is in the engaged position.

11. The electrical connection system of claim 1, wherein the plug-and-socket coupler is configured to be transitioned from a disengaged position to an engaged position by moving the first battery array and the second battery array relative to each other.

12. The electrical connection system of claim 1, wherein the plug-and-socket coupler to be transitioned from a disengaged position to the engaged position by translating the second battery array horizontally relative to the first battery array.

13. The electrical connection system of claim 1, further comprising a wedge and an enclosure, the wedge inhibiting movement of the first battery array away from the second battery array.

14. The electrical connection system of claim 1, wherein the plug-and-socket coupler is configured to be transitioned from a disengaged position to the engaged position by translating the second battery array vertically relative to the first battery array.

15. The electrical connection system of claim 1, wherein the first battery array, the second battery array, and the plug-and-socket coupler are within an enclosure of the traction battery pack.

16. A method of electrically connecting battery arrays of a traction battery, comprising:
electrically connecting a first battery array to a second battery array by moving the first battery array relative to the second battery array.

17. The method of claim 16, wherein the moving is horizontal.

18. The method of claim 16, wherein the moving is vertical.

19. The method of claim 16, further comprising electrically connecting by transitioning a plug-and-socket coupler to an engaged position.
